(19) United States
(12) Patent Application Publication
(10) Pub. No.: US 2004/0030763 A1
(43) Pub. Date: Feb. 12, 2004

(54) Method for implementing vendor-specific mangement in an inifiniband device

(76) Inventors: Venitha L. Manter, Fort Collins, CO (US); Norman Chou, Milditas, CA (US); Prasad Vajjhala, (US); S. Paul Tucker, Ft Collins, CO (US)

Correspondence Address: AGILENT TECHNOLOGIES, INC., Legal Department, DL429, Intellectual Property Administration, P.O. Box 7599, Loveland, CO, 80537-0599, US

(21) Appl. No.: 10/215,235

(22) Filed: Aug. 8, 2002

(51) Int. Cl. G06F 15/173; G06F 15/16

(52) U.S. Cl. 709/223; 709/230

(57) ABSTRACT

Internal memory elements of vendor-specific network devices are made available using standardized network protocol packets. In accordance with the invention, reserved values of an attribute identifier field may be mapped to implementation-specific nodes within a particular manufacturer's network device, while a set of reserved attribute modifier values may be mapped to implementation-specific memory elements within the node specified by the value of the attribute identifier. Access to implementation-specific device internals is therefore made possible using the standard network protocol.

### FIELD OF THE INVENTION

The present invention relates generally to network communication, and more particularly to a method and apparatus for implementing vendor-specific management in network-enabled devices.

### BACKGROUND OF THE INVENTION

In the latest generation of computer networking, computers communicate with one another over fast, packetized, serial input/output (I/O) bus architectures, in which computing hosts and peripherals are linked by a switching network, commonly referred to as a switching fabric. A number of architectures of this type exist, including the INFINIBAND™ architecture, which has been advanced by a consortium led by a group of industry leaders (including Agilent, Intel, Sun, Hewlett Packard, IBM, Compaq, Dell and Microsoft).

In some network communication protocols, there may exist methods for accessing information specific to various network devices. In these methods, however, the protocol requires for each network device to return the protocol-specified information. This means that each network device must implement functionality for interpreting the packets to allow access to the specified information. In other words, each network device must implement the specified protocol such that it operates as expected according to the protocol specification.

The above-mentioned network communication protocols are limited, however, in that they do not allow or specify any way to access memory elements specific to a particular implementation of a network device. As known in the art, while meeting the specification of the external protocol, different manufacturers/vendors of a given network device may, and typically do, implement the internal functionality of the device in different ways. Accordingly, different manufacturer/vendor/implementation-specific (hereinafter “vendor-specific”) products may include different memory elements and different memory locations of those memory elements according to the vendor-specific design of the product. Accordingly, it would be desirable to have a technique for accessing vendor-specific memory elements using the standard communication protocol of the network.

### SUMMARY OF THE INVENTION

The present invention solves the limitations of the prior art by implementing vendor-specific attributes within the communication packets defined by the network protocol.

In accordance with the invention, nodes and memory elements of interest in a particular product of a particular vendor are mapped to respective attribute identifier values and attribute modifier values of a network packet. The vendor's product implements functionality that interprets the additional attribute identifier values and corresponding attribute modifier values to map into the corresponding mapped nodes and memory elements. Vendor-specific memory elements may then be accessed using the standard network protocol with the attribute identifier and the attribute modifier fields set to the identifier and modifier values corresponding to the vendor-specific memory element of interest.

In an illustrative embodiment, the invention is used to allow access to contents of port registers and forwarding tables of an eight-port Infiniband™ switch, including registers that are otherwise inaccessible.

The invention therefore allows access to implementation-specific internals of a given vendor's product using the same network protocol as used to access network-defined memory elements.

### BRIEF DESCRIPTION OF THE DRAWINGS

A more complete appreciation of this invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of a system area network;

FIG. 2 is a block diagram of a switching fabric in accordance with the invention;

FIG. 3 is a block diagram of an individual subnet of the switching fabric of FIG. 2;

FIG. 4 is a block diagram of a switch of the switching fabric of FIGS. 1 and 2 and implementing the architecture of the switching fabric;

FIG. 5 is a block diagram of a router of the switching fabric of FIGS. 1 and 2 and implementing the architecture of the switching fabric;

FIG. 6 is a block diagram of a processor node of the switching fabric of FIGS. 1 and 2 and implementing the architecture of the switching fabric;

FIG. 7 is a block diagram of a channel adapter implemented in the processor node of FIG. 6;

FIG. 8 is a diagram illustrating the layered communication architecture of a communication packet used in the implementation of the preferred embodiment of the invention;

FIG. 9 is a packet format diagram illustrating a packet as seen at the physical layer, link layer, network layer, transport layer, and upper-level protocol layer;

FIG. 10 is a block diagram illustrating the management packet communication path;

FIG. 11 illustrates a preferred embodiment format for a Subnet Management Packet (SMP) as used in the implementation of the preferred embodiment of the invention;

FIG. 12 is a block diagram illustrating a vendor-specific switch that implements the fabric protocol; and

FIG. 13 is an illustrative format of a vendor-specific linear forwarding table used in the example switch of FIG. 12.

### DETAILED DESCRIPTION

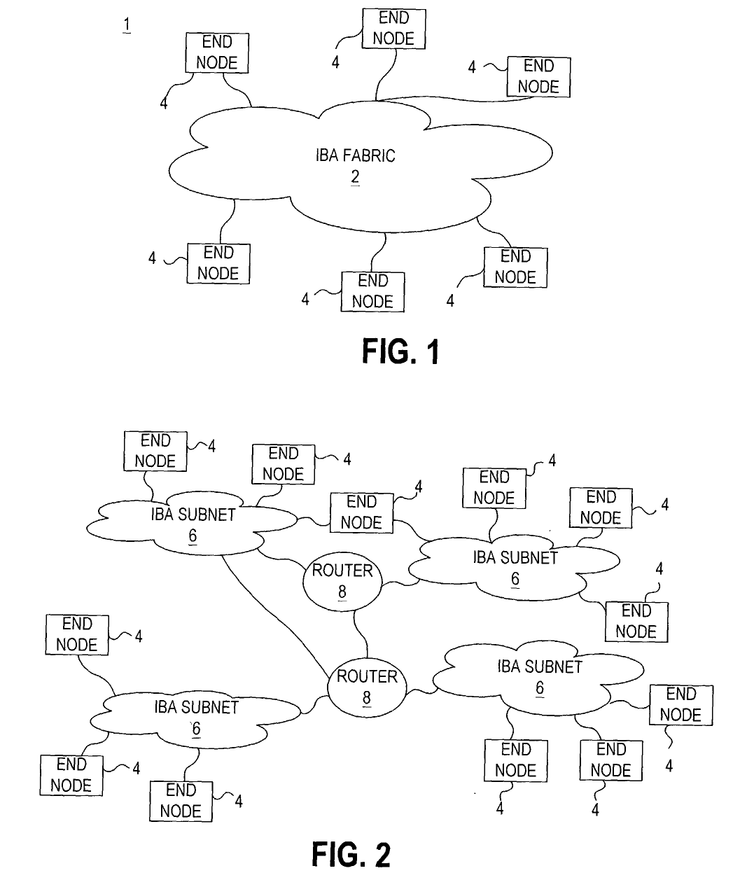

Turning now to the invention, FIG. 1 shows an example system area network 1 which connects multiple independent processor platforms, I/O platforms, and I/O devices with a switching fabric 2. In the preferred and illustrative embodiment, the system area network 1 implements the Infiniband™ architecture. The Infiniband™ Architecture (IBA) is designed around a point-to-point switched I/O fabric, whereby end node devices 4 (which can range from very inexpensive I/O devices like single chip SCSI or Ethernet adapters to very complex host computers) are interconnected by a plurality of cascaded switches, routers, channel adapters, and optionally, repeaters.

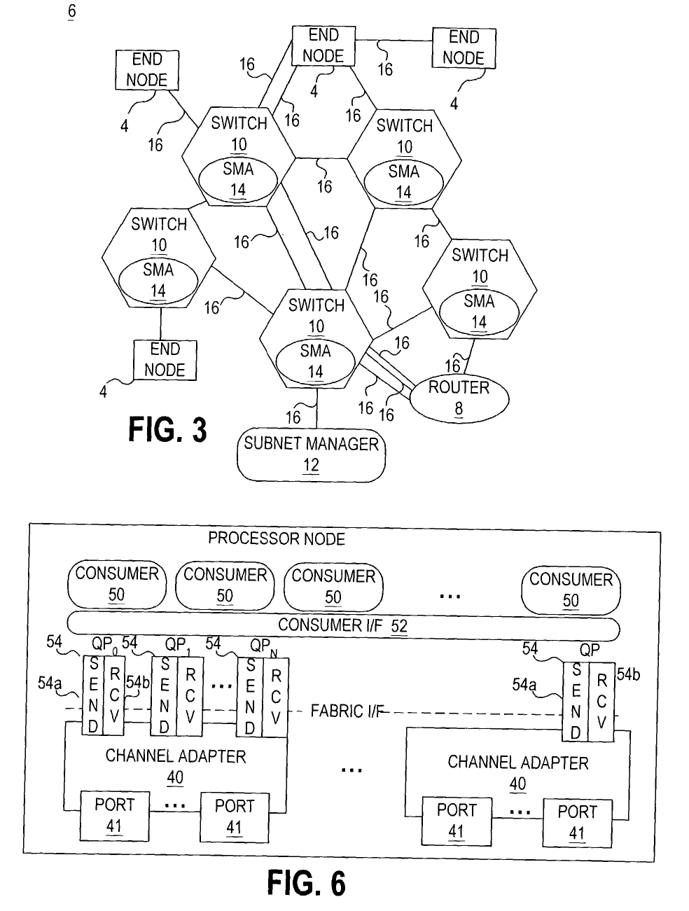

A switching fabric 2 may be subdivided into subnets 6 interconnected by routers 8 as illustrated in FIG. 2. End nodes 4 may attach to a single subnet or to multiple subnets. FIG. 3 shows the composition of an example subnet 6. As shown, each subnet is composed of nodes 4, switches 10, routers 8, and subnet managers 12 interconnected by links 16.

Each node 4, in the fabric 2 can be a processor node, an I/O unit, and/or a router 8 to another network. Each node may communicate over multiple ports and can utilize multiple paths through the switching fabric 2. Preferably, each node may attach to a single switch 10 or multiple switches and/or directly with each other. Multiple links can exist between any two nodes.

Links 16 interconnect the nodes 4, switches 10, routers 8, and subnet managers 12 to form the switching fabric 2. A link can be a copper cable, an optical cable, a wireless link, or printed circuit wiring on a backplane.

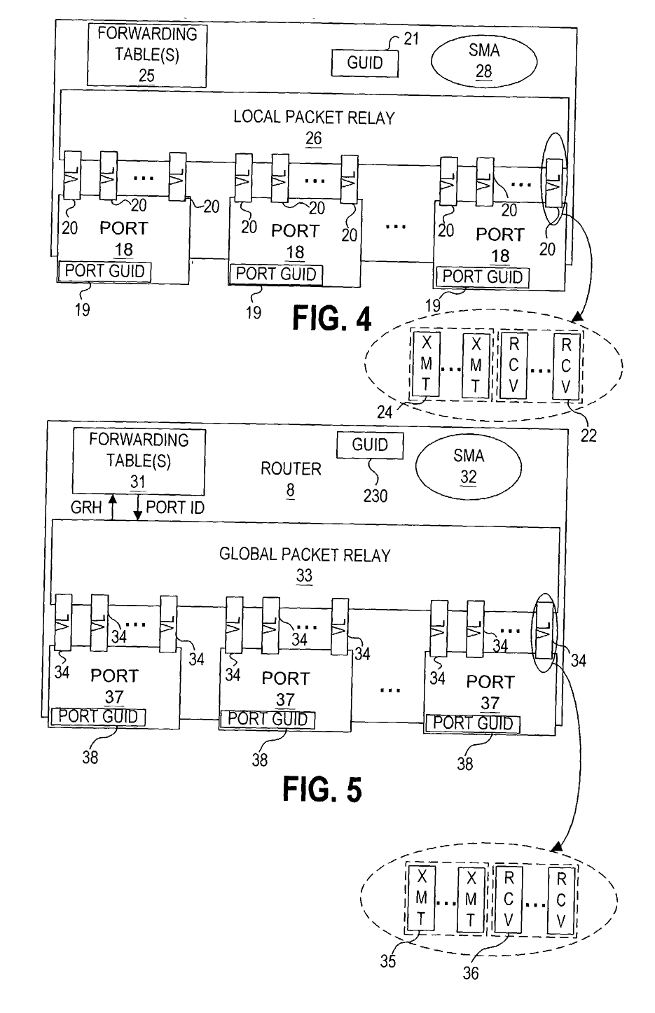

FIG. 4 is a block diagram of a switch 10. Switches are the fundamental routing component for intra-subnet routing. Switches interconnect links by relaying packets between the links. As shown, a switch 10 includes a plurality of ports 18 which each service one or more virtual lanes 20. Each virtual lane (VL) 20 is configured with its own set of independent send and receive buffers 22 and 24, which allows the port 18 to create multiple virtual links within a single physical link. A local packet relayer 26 relays a packet from one link to another based on the destination address in the received packet's local route header (LRH) (discussed hereinafter). Switches expose two or more ports between which packets are relayed. Switches are transparent to the end nodes 4, meaning that the switches are not directly addressed (except for certain management operations). Instead, packets traverse the switching fabric 2 virtually unchanged by the fabric. To this end, every destination within the subnet is configured with one or more unique Local Identifiers (LIDs). From the point of view of the switch, a LID represents a path through the switch. Switch elements are configured with forwarding tables 25. Packets contain a destination address that specifies the LID of the destination. Individual packets are forwarded within a switch 10 to Subnet Management Agent 28 or to an out-bound port or ports 18 based on the packet's Destination LID and the switch's forwarding table 25. Switches support unicast and may support multicast forwarding. Unicast is the delivery of a single packet to a single destination, while a multicast is the ability of the fabric to deliver a single packet to multiple destinations.

As described in more detail hereinafter, each switch 10 includes a Subnet Management Agent (SMA) 28, through which the LIDs and forwarding tables 25 of the switch 10 are configured by the Subnet Manager 12 (discussed hereinafter). Each switch 10 has a globally unique identifier (GUID) 21 assigned by the manufacturer of the switch. Since local identifiers (LIDs) assigned by the subnet manager 12 are not persistent (i.e., may change from one power cycle to the next), the switch GUID 21 becomes the primary object to use for persistent identification of a switch. Additionally, each port has a Port GUID 19 assigned by the switch manufacturer.

FIG. 5 is a block diagram of a router 8. As shown, a router 8 includes a plurality of ports 37 which each service one or more virtual lanes (VLs) 34. As described previously, the virtual lanes 34 are configured with independent transmit and receive buffers 35 and 36 which allow a port to create multiple virtual links over a single physical link. A global packet relayer 33 relays a packet from one link to another based on the destination address in the received packet's global route header (GRH), discussed hereinafter. Routers forward packets based on the packet's global route header and actually replace the packet's local route header as the packet passes from subnet to subnet. Routers are the fundamental routing component for inter-subnet routing. Routers interconnect subnets by relaying packets between the subnets. Routers expose one or more ports between which packets are relayed.

Routers are not completely transparent to the end nodes since the source must specify the LID 39 of the router and also provide the Global Identifier (GID) of the destination. To this end, each subnet is uniquely identified with a subnet ID known as the Subnet Prefix. The subnet manager 12 (discussed hereinafter) programs all ports with the Subnet Prefix for that subnet. Each port 37 of a router 8 has a globally unique identifier (GUID) 38 assigned by the manufacturer of the router. When combined with the Port GUID 38, this combination becomes a port's natural GID.

From the point of view of a router, the subnet prefix portion of the GID represents a path through the router 8. Individual packets are forwarded within a router 8 to an outbound port or ports 37 based on the packet's Destination GID and the router's forwarding table 31. Each router 8 forwards the packet through the next subnet to another router 8 until the packet reaches the target subnet. The last router 8 sends the packet using the LID associated with the Destination GID as the Destination LID.

FIG. 6 shows a block diagram of a processor node 4. As illustrated, each processor node 4 includes at least one channel adapter 40. Each channel adapter 40 includes one or more ports 41 that connect to the switching fabric. If the channel adapter 40 includes multiple ports, the processor node 4 appears as multiple end nodes to the fabric 2.

Each independent process and thread which executes on the node is referred to as a “consumer” 50. A processor node 4 includes a consumer interface 52. The consumer interface 52 allows consumers 50 on the processor node 4 to configure and manage the channel adapter(s) 40, and allocate (i.e., create and destroy) queue pairs 54 (discussed hereinafter), configure queue pair operation, post work request to the queue pair, and get completion status from the completion queue (discussed hereinafter).

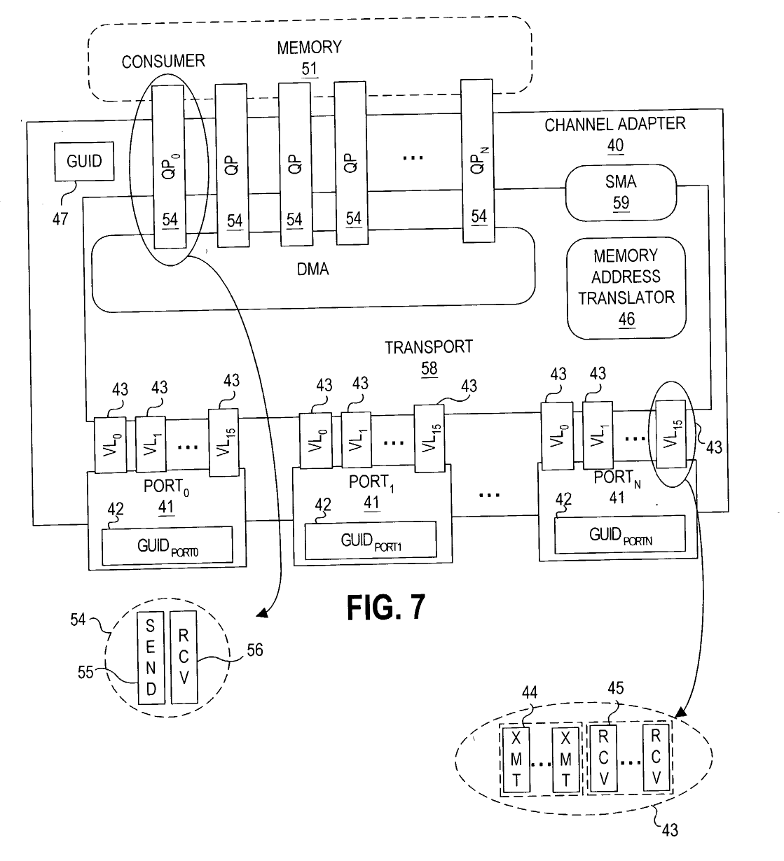

FIG. 7 shows a block diagram of a channel adapter 40. Channel adapters 40 are the consumer interface devices in the processor nodes and I/O units that generate and consume packets. Packets are the means by which data and messages are sent between nodes in the system area network 1.

As illustrated, a channel adapter 40 may have multiple ports 41. Each port 41 of a channel adapter 40 is assigned a local identifier (LID) 42 or a range of LIDs. Each port 41 has its own set of transmit and receive buffers 44 and 45 such that each port is capable of sending and receiving concurrently. Buffering is channeled through virtual lanes (VL) 43. Virtual lanes (VLs) provide a mechanism for creating multiple virtual links within a single physical link. A virtual lane 43 represents a set of transmit and receive buffers 44, 45 in a port 41. All ports 41 support a VL (e.g., VL15) reserved exclusively for subnet management, and at least one data VL (e.g., VL0-VL14) available for consumers 50. The channel adapter 40 includes a memory address translator 46 that translates virtual addresses into physical addresses. Such memory address translation algorithms are well known in the art and are beyond the scope of the invention.

The channel adapter 40 provides multiple instances of a communication interface to its consumer in the form of queue pairs (QP0-QPn) 54 each comprising a send and receive work queue 55, 56.

In operation, a consumer 50 posts work queue elements (WQE) to the QP and the channel adapter 40 interprets each WQE to perform the operation. For Send Queue operations, the channel adapter interprets the WQE, creates a request message, packages the message into one or multiple packets as necessary, adds the appropriate routing headers to the packet(s), and sends the packet(s) out the appropriate port. The port logic 41 transmits the packet(s) over the link 16 where switches 10 and routers 8 relay the packet(s) through the switching fabric 2 to the destination.

When the destination receives a packet, the port logic 41 of the destination node validates the integrity of the packet. The channel adapter 40 of the destination node associates the received packet with a particular QP 54 and uses the context of that QP 54 to process the packet and execute the operation. If necessary, the channel adapter 40 creates a response (acknowledgment) message and sends that message back to the originating node in packet format.

Each channel adapter 40 has a globally unique identifier (GUID) 47 assigned by the manufacturer of the channel adapter. Since local identifiers (LIDs) assigned by the subnet manager are not persistent (i.e., may change from one power cycle to the next), the channel adapter GUID 47 (called Node GUID) becomes the primary object to use for persistent identification of a channel adapter 40. Additionally, each port has a Port GUID 42 assigned by the channel adapter manufacturer.

Each port 41 has a Local ID (LID) assigned by the local subnet manager 12 (i.e., subnet manager 12 for the subnet 6). Within the subnet 6, LIDs are unique. Switches 10 use the LID to route packets within the subnet. The local subnet manager 12 configures the forwarding tables 25 in switches 10 based on LIDs and the topography of the fabric. Each packet contains a Source LID (SLID) that identifies the port 41a that injected the packet into the subnet and a Destination LID (DLID) that identifies the port 41b where the fabric 2 is to deliver the packet.

Each port 41 also has at least one Global ID (GID) that is globally unique (and is assigned by the channel adapter vendor).

Each channel adapter 40 has a Globally Unique Identifier (GUID) called the Node GUID assigned by the channel adapter vendor. Each of its ports 41 has a Port GUID 42 also assigned by the channel adapter vendor. The Port GUID 42 combined with the local subnet prefix becomes a ports default GID.

Subnet administration provides a GUID to LID/GID resolution service. Thus a node can persistently identify another node by remembering a Node or Port GUID.

The address of a QP is the combination of the port address (GID+LID) and the QPN. To communicate with a QP requires a vector of information including the port address (LID and/or GID), QPN, and possibly other information. This information can be obtained by a path query request addressed to Subnet Administration.

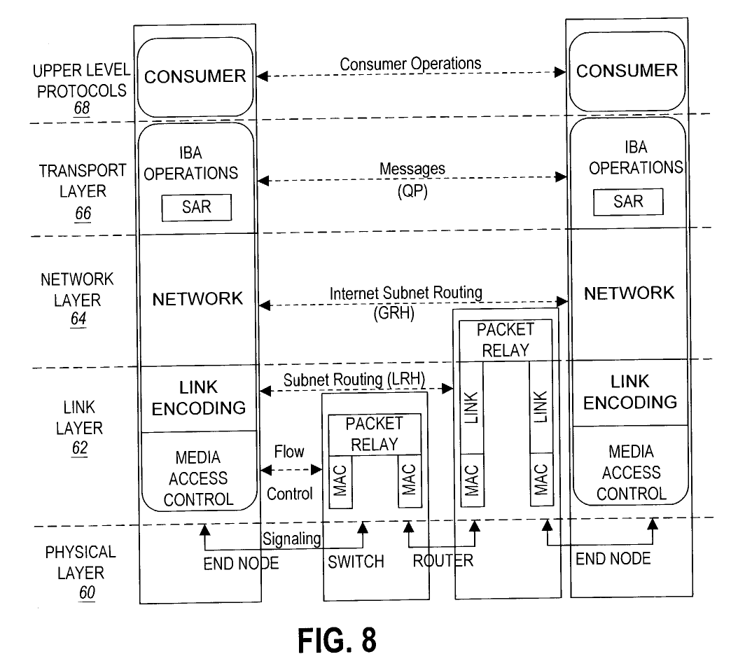

Messaging between consumers is achieved by sending packets formatted according to a layered communication architecture as illustrated in FIG. 8. The communication architecture includes a physical layer 60, a link layer 62, a network layer 64, a transport layer 66, and an upper-level protocols layer 68.

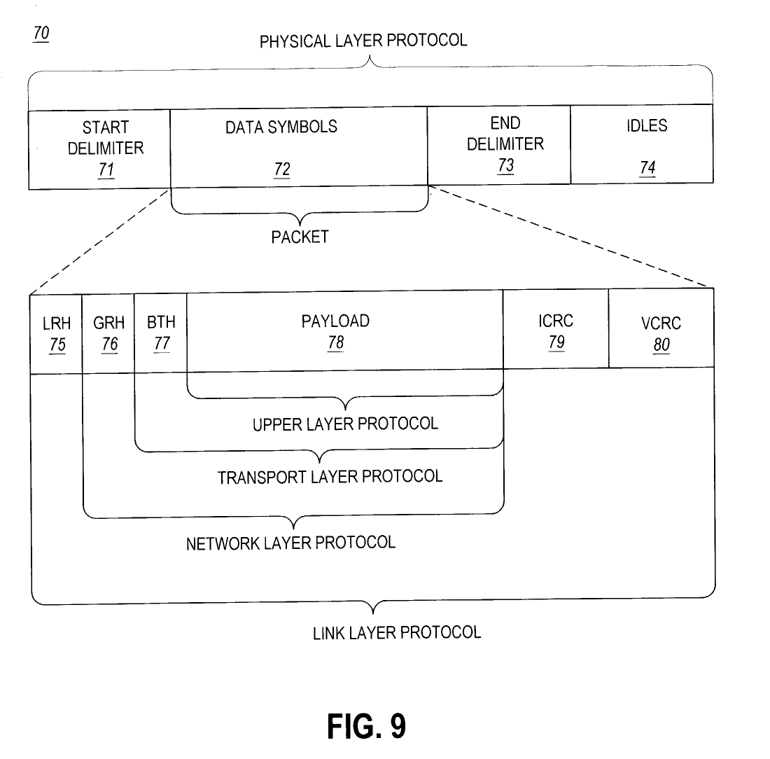

FIG. 9 illustrates a packet 70 as seen at the physical layer 60, link layer 62, network layer 64, transport layer 66, and upper-level protocol layer 68.

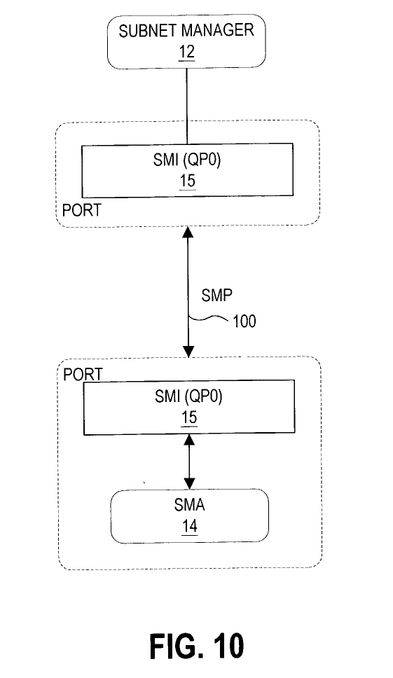

With reference to FIGS. 9 and 10, the physical layer 60 specifies how bits are placed on the link to form symbols and defines the symbols used for framing (i.e., start-of-packet 71 and end-of-packet 73), data symbols 72, and fill 74 between packets (idles). It specifies the signaling protocol as to what constitutes a validly formed packet 70 (i.e., symbol encoding, proper alignment of framing symbols, no invalid or non-data symbols between start and end delimiters, no disparity errors, synchronization method, etc.). The physical layer 60 specifies the bit rates, media, connectors, signaling techniques, etc.

The link layer 62 describes the packet format and protocols for packet operation, e.g., flow control and how packets are routed within a subnet between the source and destination. A packet at the link layer includes at least a local route header (LRH) 75 which identifies the local source and local destination ports 41a, 41b where switches 10 will route the packet 70.

The network layer 64 describes the protocol for routing a packet 70 between subnets 6. Each subnet 6 has a unique subnet ID called the subnet Prefix. When combined with a Port GUID, this combination becomes a port's Global ID (GID). The source places the GID of the destination in the global router header (GRH) and LID of the router in the local route header (LRH) 75. The GRH is a field (or header) in the network layer of a packet 70 targeted to destinations outside the sender's local subnet 6. The LRH 75 is a field (or header) at the link layer 62 used for routing through switches 10 within a subnet 6. Each router 8 forwards the packet 70 through the next subnet 6 to another router 8 until the packet 70 reaches the target subnet. The last router 8 replaces the LRH 75 using the LID of the destination.

The network and link protocols are used to deliver a packet 70 to the desired destination. The transport portion 66 of the packet 70 is used to deliver the packet 70 to the proper QP 54 and instructs the QP 54 how to process the packet's data. Preferably, the transport portion 66 of the packet includes a field (e.g., base transport header (BTH)) 77 which specifies the destination QP 54b and indicates the operation code and packet sequence number, among other information.

Upper level protocols 68 specific to the destination node specify the contents of the remaining payload of the packet.

The switching fabric 2 requires a management infrastructure to support a number of general management services. In the preferred and illustrative embodiment which implements the Infiniband™ architecture, the management infrastructure requires a subnet manager 12 in each subnet 6 and a subnet management agent 14 in each node 4, switch 10, and router 8 of the subnet 6. This is illustrated in FIG. 3. Each subnet 6 has at least one Subnet Manager (SM) 12.

A Subnet Manager (SM) 12 is an entity attached to a subnet 6 that is responsible for configuring and managing the switches 10, routers 8, and channel adapters 40 in the subnet 6. For example, the subnet manager 12 configures channel adapters 40 with the local addresses for each physical port (i.e., the port's LID).

The SM 12 operates to discover the subnet topology, configure each channel adapter port 41 with a range of LIDs, GIDs, and the subnet prefix, configure each switch 10 with a LID, the subnet prefix, and forwarding tables, among other functions.

Each node in a subnet provides a subnet management agent (SMA) 14 that the SM 12 accesses through an interface called the Subnet Management Interface (SMI) 15. SMI 15 supports methods from a Subnet Manager 12 to discover and configure devices and manage the switching fabric 2. SMI 15 uses a special class of packet called a Subnet Management Packet (SMP) 100 which is directed to a special reserved queue pair (QPO), as illustrated in FIG. 10. Each port directs SMPs 100 to a special virtual lane (e.g., VL15) reserved for SMPs.

The communication between the SM 12 and the SMAs 14 is performed with Subnet Management Packets (SMPs) 100. SMPs 100 provide a fundamental mechanism for subnet management.

There are two types of SMPs 100: LID routed and directed route. LID routed SMPs are forwarded through the subnet (by the switches) based on the LID of the destination. Directed route SMPs are forwarded based on a vector of port numbers that define a path through the subnet. Directed route SMPs are used to implement several management functions, in particular, before the LIDs are assigned to the nodes.

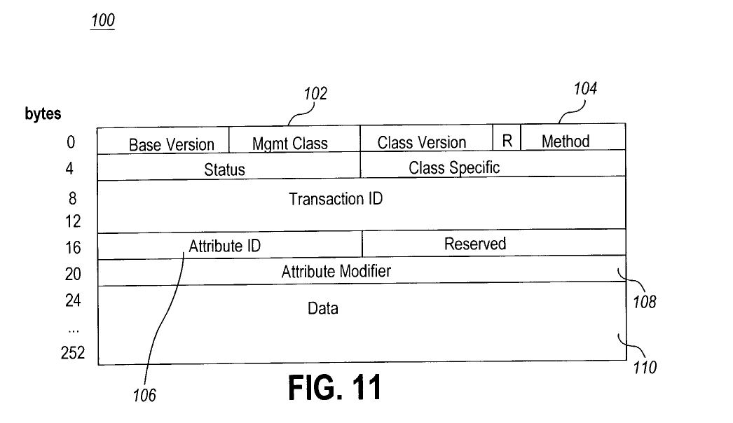

FIG. 11 illustrates the preferred embodiment format for a Subnet Management Packet (SMP) 100. As illustrated, the SMP 100 is a fixed length 256-byte packet that includes a plurality of fields. The fields include at least the MgmtClass field 102, a Method field 104, an AttributeID field 106, an AttributeModifier field 108, and a Data field 110.

The MgmtClass field 102 defines the management class of the SMP 100. Each different management class is assigned a unique MgmtClass value. In the illustrative embodiment, the MgmtClass is set to a value representing the subnet management class defining methods and attributes associated with discovering, initializing, and maintaining a given subnet.

The Method field 104 specifies the method to perform based on the management class specified in the MgmtClass field 102. Methods define the operations that a management class supports. Some common management methods are listed in TABLE 1. Each method for a specific management class is assigned a unique Method value.

TABLE 1

| Name | Type | Value | Description |
|---|---|---|---|
| Get( ) | Request | 0x01 | Request (read) an attribute from a |
| | | | channel adapter, switch, or router. |
| Set( ) | Request | 0x02 | Request a set (write) of an attribute in a |
| | | | channel adapter, switch, or router. |
| GetResp( ) | Response | 0x81 | The response from an attribute Get or |
| | | | Set request. |

The AttributeID field 106 defines objects being operated on, and the Management Class Attributes define the data which a management class manipulates. Attributes are composite structures consisting of components typically representing hardware registers in channel adapters, switches, or routers. Each management class defines its own set of attributes, and each attribute within a particular management class is assigned a unique AttributeID.

Some attributes have associated AttributeModifiers, specified in the AttributeModifier field 108, which further qualify or modify the application of the attribute.

SMPs 100 are exchanged between a SM 12 and SMAs 14 on the subnet 6. SMPs 100 travel exclusively over a reserved virtual lane (e.g., VL 15) and are addressed exclusively to a reserved queue pair (e.g., QPO), as illustrated in FIG. 16.

TABLE 2 summarizes some of the subnet management attributes, and TABLE 3 indicates which methods apply to each attribute.

TABLE 2

| | Attribute | Attribute | | Required |
|---|---|---|---|---|
| Attribute Name | ID | Modifier | Description | for |
| NodeDescription | 0x0010 | 0x0000_0000 | Node | All Nodes |
| | | | Description | |
| | | | String | |
| NodeInfo | 0x011 | 0x0000_0000 | Generic Node | All Nodes |
| | | | Data | |
| SwitchInfo | 0x0012 | 0x0000_0000 | Switch | Switches |
| | | | Information | |
| GUIDInfo | 0x0014 | GUID Block | Assigned | All CAs, |
| | | | GUIDs | Routers, and |
| | | | | Switch Mgmt |
| | | | | Ports |
| PortInfo | 0x0015 | Port Number | Port | All Ports on |
| | | | Information | All Nodes |
| SLtoVLMapTable | 0x0017 | Input/Output | Service Level | All Ports on |
| | | Port Number | to Virtual Lane | All Nodes |
| | | | mapping | |
| | | | information | |
| LinearFwdingTable | 0x0019 | LID Block | Linear | Switches |
| | | | Forwarding | |
| | | | Table | |
| | | | Information | |
| RandomFwdgTable | 0x001A | LID Block | Random | Switches |
| | | | Forwarding | |
| | | | Database | |
| | | | Information | |
| MulticastFwdgTable | 0x001B | LID Block | Multicast | Switches |
| | | | Forwarding | |
| | | | Database | |
| | | | Information | |
| SMInfo | 0x0020 | 0x0000_0000-0x0000_0005 | Subnet | All nodes |
| | | | Management | hosting an |
| | | | Information | SM |
| VendorDiag | 0x0030 | 0x0000_0000-0x0000_FFFF | Vendor | All Ports on |
| | | | Specific | All Nodes |
| | | | Diagnotic | |
| LedInfo | 0x0031 | 0x0000_0000 | Turn on/off | All nodes |
| | | | LED | |
| | 0xFF00-0xFFFF | 0x0000_0000-0x0000_FFFF | Range | |
| | | | reserved for | |
| | | | Vendor | |
| | | | Specific | |
| | | | Attributes | |

TABLE 3

| Attribute Name | Get | Set |
|---|---|---|
| NodeDescription | x | |
| NodeInfo | x | |
| SwitchInfo | x | x |
| GUIDInfo | x | x |
| Portinfo | x | x |
| SLtoVLMappingTable | x | x |
| LinearForwardingTable | x | x |
| MulticastForwardingTable | x | x |
| SMInfo | x | x |
| VendorDiag | x | |
| LedInfo | x | x |

As shown in TABLE 2, the number of attributes defined for SMPs do not utilize the entire mapping space. In particular, in the illustrative embodiment, the range of possible attribute values between 0xFF00−0xFFFF are reserved for vendor-specific attributes. However, the Infiniband™ specification does not specify how or what these vendor-specific attributes are defined as.

In accordance with the invention, product manufacturers and vendors define the vendor-specific attributes to map into and access specific memory elements of a vendor's particular product. For example, a vendor's product may include state machine registers, processor registers, memory tables, and/or general memory that are not accessible according to the specified protocol (i.e., the Infiniband™ specification). Depending on the function and design of the particular product, different memory elements (i.e., the registers, or memory locations) may be of more interest than others to vendor technicians and product users. For example, in a debugging situation, it may be quite useful to have access to the contents of certain registers, stacks, and tables. In a product maintenance situation, it may be useful to have access to registers or memory locations storing total power-on hours and other usage statistics that may be accumulated and stored over the life of the product. The invention therefore allows each vendor to utilize the unspecified bits of a management SMP AttributeID and AttributeModifier to map into the internal memory of a vendor's product and customize the mapping to provide access to different memory elements of interest depending on, and specific to, the particular product. The mapping may be different for each vendor and for each different product manufactured by the vendor.

As an illustrative embodiment, the vendor's product may be a switch that supports the switching fabric (e.g., an InfiniBand™ switch). As previously described, a switch interconnects links by forwarding packets between the links. Switches are transparent to the end nodes and are not directly addressed, except for management operations. To this end, as described previously, every destination port within the network is configured with one or more unique Local Identifiers (LIDs). From the point of view of a switch, a LID represents a path from the input port through the switch to an output port of the switch. Switch elements are configured with forwarding tables. Packets are addressed to their ultimate destination on the subnet using a destination LID (DLID), and not to the intervening switches. Individual packets are forwarded within a switch to an outbound port or ports based on the packet's DLID field and the switch's forwarding table.

A Subnet Manager (SM) configures switches including loading their forwarding tables. The entity that communicates with the SM for the purpose of configuring the switch is the Subnet Management Agent (SMA).

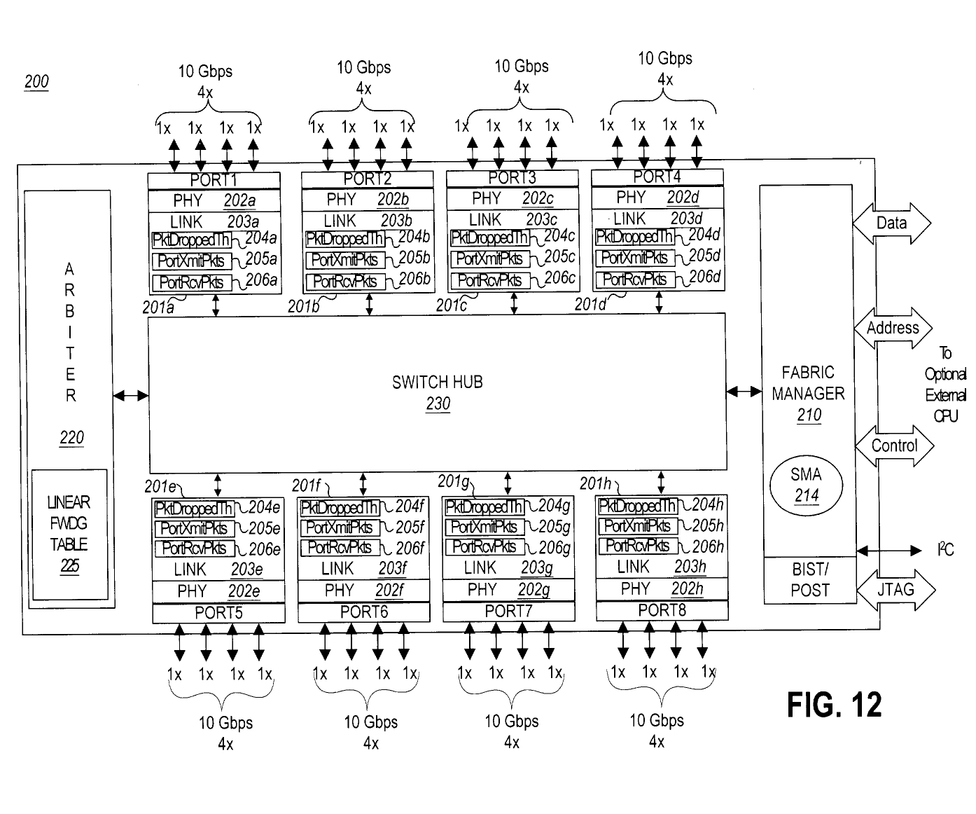

FIG. 12 is a block diagram illustrating a vendor-specific switch 200 that implements the fabric protocol. As illustrated, the switch 200 comprises eight ports 201a-201h, each of which can run at 4× or 1× operating mode. Each port 201a-201h contains an independent physical layer (PHY) 202 and link layer (LINK) 203. The physical layer 202 includes the transceiver for sending and receiving data packets.

The link layer 203 supports a plurality of virtual lanes (VLs) and other functions such as Link state and status, error detecting and recording, flow control generation, and output buffering. For example, in the illustrative embodiment, the vendor may have defined several memory elements (for example, registers) which store information and/or statistics related to the port's link layer. In the illustrative embodiment, the link layer 203 implements a PacketDroppedThreshold register which stores the number of packets discarded by a port before a trap is triggered. The contents of the PacketDroppedThreshold register is otherwise inaccessible outside implementation of the present invention. The link layer 203 also implements a PortXmitPkts register 205 which stores the total number of packets transmitted by the port, and a PortRcvPkts register 206 which stores the number of packets received by the port.

The switch includes a management block 210. The management block 210 includes agents for various programming quality of service, performance monitoring, and error detecting services. The management block includes the Subnet Management Agent 214 of the switch 200.

The switch 200 also includes a switch hub 230 and arbiter block 220. The switch hub 230 contains the connections for relaying packets between ports 201. The arbiter 220 controls the packet relay functionality and contains the forwarding tables 225 of the switch 200.

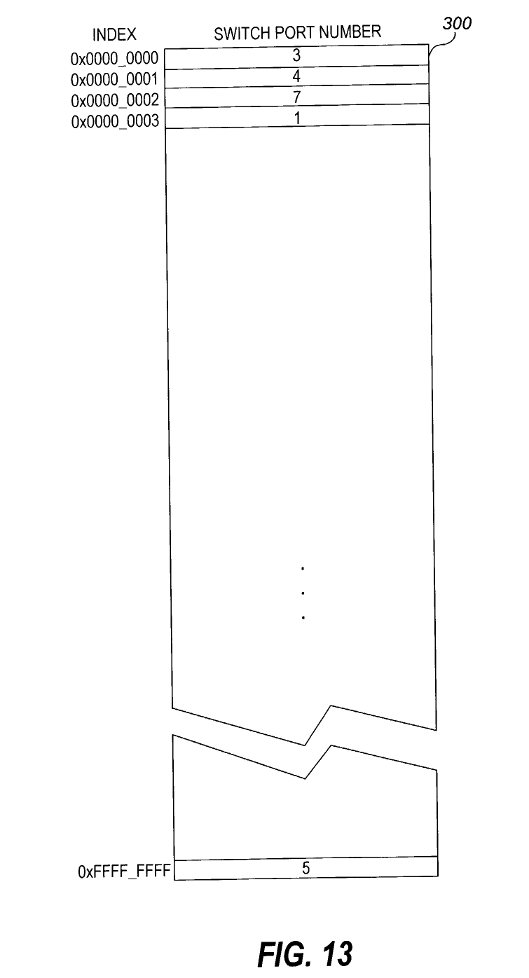

In the illustrative embodiment, the forwarding table 225 is a linear forwarding table, for example as shown at 300 in FIG. 13. The linear forwarding table 300 provides a simple map from LID to destination port. Conceptually, the table itself contains only destination ports; the LID acts as an index into the table to an entry containing the port to which packets with the corresponding LID are to be forwarded. The linear forwarding table 300 contains a port entry 226a-226n for each LID starting from zero and incrementing by one up to the size n of the forwarding table 300.

Table 4 illustrates an example definition of the vendor-specific attribute and attribute modifier. As shown when the AttributeID field is set to a value 0xFF01−0xFF08, the AttributeID field is used to specify a particular port in the switch, and the corresponding AttributeModifier field specifies a particular register in that port. For Example, when the AttributeID field is set to 0xFF01 with AttributeModifier field set to 0x0000_{—}0000, the memory element accessed is the PacketDroppedThreshold register 204a of Port 1 201a. When the AttributeID field is set to 0xFF01 with AttributeModifier field set to 0x0000_{—}0001, the memory element accessed is the PortXmitPkts register 205a of Port 1 201a. When the AttributeID field is set to 0XFF01 with AttributeModifier field set to 0x0000_{—}0002, the memory element accessed is the PortRcvPkts register 206a of Port 1 201a. Like memory elements may be accessed similarly in each of Ports 2-8 by appropriately setting the Attributeld field and AttributeModifier field of the SMP 100 to the values in Table 4 corresponding to the desired memory element. In the illustrative embodiment, when the AttributeID field is set to the value 0xFF10, the memory element accessed is the Linear Forwarding Table 225/300, and the corresponding value of the AttributeModifier field of the SMP 100 specifies a particular block of entries in the forwarding table 225/300.

TABLE 4

| AttributeID | | |
|---|---|---|
| (Internal | AttributeModifier | |
| Node | (Word Address associated | |
| Address) | with Internal Node Address) | Memory Element |
| 0xFF01 | | Link Port 1 |
| | 0x0000_0000 | PacketDroppedThreshold |
| | 0x0000_0001 | PortXmitPkts |
| | 0x0000_0002 | PortRcvPkts |
| 0xFF02 | | Link Port 2 |
| | 0x0000_0000 | PacketDroppedThreshold |
| | 0x0000_0001 | PortXmitPkts |
| | 0x0000_0002 | PortRcvPkts |
| 0xFF03 | | Link Port 3 |
| | 0x0000_0000 | PacketDroppedThreshold |
| | 0x0000_0001 | PortXmitPkts |
| | 0x0000_0002 | PortRcvPkts |
| 0xFF04 | | Link Port 4 |
| | 0x0000_0000 | PacketDroppedThreshold |
| | 0x0000_0001 | PortXmitPkts |
| | 0x0000_0002 | PortRcvPkts |
| 0xFF05 | | Link Port 5 |
| | 0x0000_0000 | PacketDroppedThreshold |
| | 0x0000_0001 | PortXmitPkts |
| | 0x0000_0002 | PortRcvPkts |
| 0xFF06 | | Link Port 6 |
| | 0x0000_0000 | PacketDroppedThreshold |
| | 0x0000_0001 | PortXmitPkts |
| | 0x0000_0002 | PortRcvPkts |
| 0xFF07 | | Link Port 7 |
| | 0x0000_0000 | PacketDroppedThreshold |
| | 0x0000_0001 | PortXmitPkts |
| | 0x0000_0002 | PortRcvPkts |
| 0xFF08 | | Link Port 8 |
| | 0x0000_0000 | PacketDroppedThreshold |
| | 0x0000_0001 | PortXmitPkts |
| | 0x0000_0002 | PortRcvPkts |
| 0xFF10 | | Linear Forwarding Table |
| | 0x0000_0000 | entries 0 to 63 |
| | 0x0000_0001 | entries 64-127 |
| | 0x0000_0002 | entries 128-195 |
| | . | . |
| | . | . |
| | . | . |
| | Up to 0x0000_FFFF (depending | |
| | on size of Linear Forwarding | |
| | Table) | |

The method of vendor-specific management differs from other potential solutions in that it provides the Subnet Manager (SM) extensive read and write access to the internals of each switch in its network. The invention is advantageous in several ways, including its implementation simplicity in that it utilizes logic that must already exist for support of other required attributes. The invention extends the existing logic to allow access not only to Infiniband™-defined registers but also to implementation-specific registers of various products by various manufacturers.

Although this preferred embodiment of the present invention has been disclosed for illustrative purposes, those skilled in the art will appreciate that various modifications, additions and substitutions are possible, without departing from the scope and spirit of the invention as disclosed in the accompanying claims. For example, it should be understood that while the invention has been described in the context of the Infiniband™ architecture, the invention may be used in any network messaging scheme that supports Get and Send messages using Attributes and corresponding Attribute modifiers. It is also possible that other benefits or uses of the currently disclosed invention will become apparent over time.

What is claimed is:

1. A network communication packet implemented according to a standardized network protocol for a switching fabric, said switching fabric coupled to a plurality of network devices, said network communication packet comprising:
an attribute identifier field settable to one or more attribute identifier values each of which maps to a corresponding implementation-specific node for a given implementation-specific network device within said switching fabric; and
an attribute modifier field setable to one or more attribute modifier values each of which maps to a corresponding implementation-specific memory element within said corresponding implementation-specific node indicated by said corresponding attribute identifier value.

2. A network communication packet in accordance with claim 1, wherein:
said attribute identifier field comprises a first attribute identifier value mapped to a first implementation-specific node within a first implementation-specific network device in said switching fabric; and
said attribute modifier field comprises a first attribute modifier value mapped to a first implementation-specific memory element within said first implementation-specific node of said first implementation-specific network device.

3. A network device configured to process one or more packets received over a network according to a standardized communication protocol, comprising:
a first implementation-specific node within said network device mapped to a first attribute identifier value for an attribute identifier field of said one or more packets;
a first memory element within said implementation-specific node mapped to a first attribute modifier value for an attribute modifier field of said one or more packets; and
a processor which interprets said first attribute identifier value as representing said first implementation-specific node, and when said processor interprets said first attribute identifier as representing said first implementation-specific node, said processor interprets said first attribute modifier value as representing said first memory element within said first implementation-specific node.

4. A network device in accordance with claim 3, wherein:
said attribute identifier field and said attribute modifier field comprise fields of a network management packet.

5. A network device in accordance with claim 3, comprising:
one or more additional memory elements within said first implementation-specific node mapped to one or more additional respective attribute modifier values; and
when said processor interprets said first attribute identifier value as representing said first implementation-specific node, said processor interprets a respective one of said one or more additional respective attribute modifier values as representing said respective one or more additional memory elements within said first implementation-specific node.

6. A network device in accordance with claim 5, comprising:
one or more additional implementation-specific nodes mapped to one or more additional respective attribute identifier values for said attribute identifier field of said one or more packets; and
wherein said processor interprets said one or more additional respective attribute identifier values in said attribute identifier field as representing said respective one or more additional implementation-specific nodes.

7. A network device in accordance with claim 6, wherein:
said attribute identifier field and said attribute modifier field comprise fields of a network management packet.

8. A network device in accordance with claim 6, comprising:
one or more additional memory elements within one or more of said respective one or more additional implementation-specific nodes, said one or more additional memory elements mapped to one or more additional respective attribute modifier values for said attribute modifier field of said one or more packets; and
when said processor interprets said attribute identifier field value as representing a respective one of said one or more additional implementation-specific nodes, said processor interprets said respective one or more attribute modifier values as representing said respective one or more additional memory elements within said represented implementation-specific node.

9. A network device in accordance with claim 3, comprising:
one or more additional implementation-specific nodes mapped to one or more additional respective attribute identifier values for said attribute identifier field of said one or more packets; and
wherein said processor interprets said one or more additional respective attribute identifier values in said attribute identifier field as representing said respective one or more additional implementation-specific nodes.

10. A network device in accordance with claim 9, comprising:
one or more additional memory elements within one or more of said respective one or more additional implementation-specific nodes, said one or more additional memory elements mapped to one or more additional respective attribute modifier values for said attribute modifier field of said one or more packets; and
when said processor interprets said attribute identifier field value as representing a respective one of said one or more additional implementation-specific nodes, said processor interprets said respective one or more attribute modifier values as representing said respective one or more additional memory elements within said represented implementation-specific node.

11. A network device in accordance with claim 10, wherein:
said attribute identifier field and said attribute modifier field comprise fields of a network management packet.

12. A method for allowing access to implementation-specific memory elements of a network device using a standard protocol network communication packet, said packet comprising an attribute identifier field and an attribute modifier field, said method comprising:
mapping a first attribute identifier value of said attribute identifier field to an implementation-specific node within said network device; and
mapping a first attribute modifier value of said attribute modifier field to an implementation-specific memory element within said implementation-specific node mapped to said first attribute identifier value.

13. A method in accordance with claim 12, comprising:
mapping one or more additional attribute modifier values of said attribute modifier field to respective one or more implementation-specific memory elements within said implementation-specific node mapped to said first attribute identifier value.

14. A method in accordance with claim 13, comprising:
mapping one or more additional attribute identifier values of said attribute identifier field to respective one or more implementation-specific nodes within said network device; and
for each said one or more additional attribute identifier values, mapping one or more respective attribute modifier values of said attribute modifier field to one or more implementation-specific memory element within said implementation-specific node mapped to said respective one or said one or more additional attribute identifier values.

15. A method in accordance with claim 12, comprising:
mapping one or more additional attribute identifier values of said attribute identifier field to respective one or more implementation-specific nodes within said network device; and
for each said one or more additional attribute identifier values, mapping one or more respective attribute modifier values of said attribute modifier field to one or more implementation-specific memory element within said implementation-specific node mapped to said respective one or said one or more additional attribute identifier values.

16. A method for allowing access to implementation-specific memory elements of a network device using a standard protocol network communication packet, said packet comprising an attribute identifier field and an attribute modifier field, said method comprising:
setting said attribute identifier field to a first attribute identifier value, said first attribute identifier value mapped to an implementation-specific node within said network device; and
setting said attribute modifier field to a first attribute modifier value, said first attribute modifier value mapped to an implementation-specific memory element within said implementation-specific node mapped to said first attribute identifier value.

17. A method in accordance with claim 16, comprising:
setting said attribute modifier field to one or more additional attribute modifier values, said one or more additional attribute modifier values mapped to respective one or more implementation-specific memory elements within said implementation-specific node mapped to said first attribute identifier value.

18. A method in accordance with claim 17, comprising:
setting said attribute identifier field to one or more additional attribute identifier values, said one or more additional attribute identifier values mapped to respective one or more implementation-specific nodes within said network device; and
for each said one or more additional attribute identifier values, setting said attribute modifier field to one or more respective attribute modifier values, said one or more respective attribute modifier values mapped to one or more implementation-specific memory element within said implementation-specific node mapped to said respective one or said one or more additional attribute identifier values.

19. A method in accordance with claim 16, comprising:
setting said attribute identifier field to one or more additional attribute identifier values, said one or more additional attribute identifier values mapped to respective one or more implementation-specific nodes within said network device; and
for each said one or more additional attribute identifier values, setting said attribute modifier field to one or more respective attribute modifier values, said one or more respective attribute modifier values mapped to one or more implementation-specific memory element within said implementation-specific node mapped to said respective one or said one or more additional attribute identifier values.
